(19) United States
(12) Patent Application Publication
(10) Pub. No.: US 2013/0335494 A1
(43) Pub. Date: Dec. 19, 2013

(54) DIGITAL INKJET PRINTING MACHINE WITH TRANSPARENT INK

(71) Applicants: TSAI CHEN-CHIEN, New Taipei City (TW); YEN CHIH-HUA, New Taipei City (TW); LIN WAN-BAO, New Taipei City (TW); LAI CHIA-SHOU, New Taipei City (TW)

(72) Inventors: TSAI CHEN-CHIEN, New Taipei City (TW); YEN CHIH-HUA, New Taipei City (TW); LIN WAN-BAO, New Taipei City (TW); LAI CHIA-SHOU, New Taipei City (TW)

(21) Appl. No.: 13/527,046

(22) Filed: Jun. 19, 2012

(51) Int. Cl. B41J 2/21

(52) U.S. Cl. 347/102

(57) ABSTRACT

A digital inkjet printing machine with transparent ink comprising an inkjet module, at least one UV light projection device and a working platform with heating function is disclosed, wherein the working platform is used for heating a work piece during or after the jetting of ink on the work piece on the working platform for hardening the ink droplets thereon, and the inkjet module has a plurality of colored ink cartridges and at least one transparent ink cartridge filled with transparent UV curable ink; the at least one UV light projection device is disposed on a side of the inkjet module for irradiating UV light downward on a surface of the work piece on the working platform in order to solidify the transparent UV curable ink droplets jetted thereon, and to form a three-dimensional transparent color layer on the surface of the printed work piece.

### BACKGROUND OF THE INVENTION

1. Field of Invention

The present invention relates to a digital inkjet printing machine with transparent ink and more particularly to a digital inkjet printing machine with an UV light projection device and an transparent UV curable ink cartridge disposed on an inkjet module by which a three-dimensional transparent color layer is formed on a surface of a printed work piece.

2. Related Art

The solvent based digital inkjet printing machine (printer for large-format prints) in the market is widely used in printing commercial advertisements, posters and high quality arts because of its excellent printing quality and high performance. The ink cartridge of an inkjet module of the digital inkjet printing machine is usually filled with volatile solvent based ink for enhancing the color quality and stability. However, the solvent based ink can not be absorbed by the work piece immediately and the patterns on the work piece require longer time to form. Therefore the ink is dried and solidified on the surface of the work piece to cause uneven formation. This problem is even more obvious for a to-be-printed work piece made of material (e.g. plastic) which can not absorb the ink well. Thus, the digital inkjet printing machine is usually disposed with a heating device for heating the work piece in order to harden the ink droplets on the work piece, so that the ink droplets can be dried speedily. Even though eco-friendly solvent based ink, water based ink and non-solvent ink are provided for using with the digital inkjet printing machine, the heating device is still required for hardening the ink droplets on the work piece in order that the ink droplets can be fixed and dried effectively to ensure the printing quality.

Volatile transparent ink is not existed in the market for using in the digital inkjet printing machine to print transparent color. In order that the effect of transparent color can be presented on the surface of a work piece, the printed work piece has to be treated with liquid coating or cold laminating. Therefore, there is a bottleneck in the printing function of the digital inkjet printing machine.

In view of the above problems and in order to overcome the drawbacks, a digital inkjet printing machine with transparent ink is provided. An UV light projection device is disposed on an inkjet module for solidifying the transparent UV curable ink droplets jetted on the surface of a work piece speedily and forming a three-dimensional transparent color on the surface of the printed work piece.

### SUMMARY OF THE INVENTION

A primary objective of the present invention is to provide a digital inkjet printing machine with transparent ink. A heating device is disposed on the digital inkjet printing machine and at least one transparent ink cartridge filled with transparent UV curable ink is disposed on an inkjet module of the digital inkjet printing machine. At least one UV light projection device is disposed on a side of the inkjet module for solidifying the transparent UV curable ink droplets jetted on the surface of a work piece and forming a transparent color layer on the surface of the work piece.

In order to achieve the above-mentioned objective, the digital inkjet printing machine with transparent ink provided by the present invention comprises an inkjet module, at least one UV light projection device and a working platform with heating function. The working platform is used for heating a work piece during or after the jetting of ink on the work piece on the working platform in order to harden the ink droplets on the work piece. The inkjet module has a plurality of colored ink cartridges and at least one transparent ink cartridge filled with transparent UV curable ink. The at least one UV light projection device is disposed on a side of the inkjet module for irradiating UV light downward on a surface of the work piece on the working platform in order to solidify the transparent UV curable ink droplets jetted on the surface of the work piece.

When the digital inkjet printing machine with transparent ink is embodied, the colored ink cartridges are filled with solvent based ink.

When the digital inkjet printing machine with transparent ink is embodied, the colored ink cartridges are filled with non-solvent ink.

When the digital inkjet printing machine with transparent ink is embodied, the colored ink cartridges are filled with eco-friendly solvent based ink.

When the digital inkjet printing machine with transparent ink is embodied, the colored ink cartridges are filled with water based ink.

The present invention will become more fully understood by reference to the following detailed description thereof when read in conjunction with the attached drawings.

### BRIEF DESCRIPTION OF THE DRAWINGS

FIG. 1 is a structural illustration of a digital inkjet printing machine with transparent ink of the present invention.

### DETAILED DESCRIPTION OF THE INVENTION

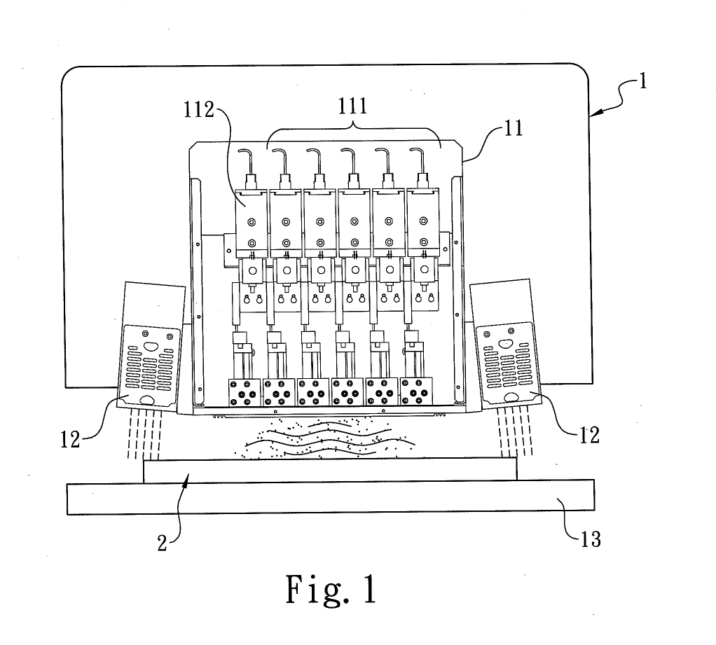

FIG. 1 is a structural illustration of a digital inkjet printing machine with transparent ink 1 according to an embodiment of the present invention. The digital inkjet printing machine with transparent ink 1 comprises an inkjet module 11; an UV light projection device 12 disposed on a left side and a right side of the inkjet module 11 respectively and a working platform 13 with heating function. The working platform 13 is used for supporting a to-be-printed work piece 2 and for heating the work piece 2 during or after the jetting of ink on the work piece 2 on the working platform 13 by the inkjet module 11 in order to harden the ink droplets on the work piece 2.

The inkjet module 11 has a plurality of colored ink cartridges 111 and a transparent ink cartridge 112 disposed by a left side of the colored ink cartridges 111. The colored ink cartridges 111 are filled with solvent based ink with different colors of blue, red, yellow, black, light blue, light red, orange or green respectively. The transparent ink cartridge 112 is filled with transparent UV curable ink. The colored ink cartridges 111 can also be filled with different colored non-solvent ink, eco-friendly solvent based ink or water based ink respectively. The transparent UV curable ink filled in the transparent ink cartridge 112 can be non-solvent or water based transparent UV curable ink.

When the digital inkjet printing machine with transparent ink 1 is embodied, patterns are printed on the work piece 2 by the colored ink cartridges 111 of the inkjet module 11 first. Then, the transparent UV curable ink is jetted on the printed patterns of the work piece 2 by the transparent ink cartridge 112 of the inkjet module 11 based on a preset graphic data. During the jetting of the transparent UV curable ink, the UV light projection devices 12 disposed on the inkjet module 11 are turned on to irradiate UV light downward on the surface of the work piece 2 on the working platform 13 in order to solidify the transparent UV curable ink droplets jetted on the patterns of the work piece 2 immediately. Thereby, after all the printing jobs are done for the work piece 2, a transparent color layer with the graphic data is formed on the patterns of the work piece 2.

When the digital inkjet printing machine with transparent ink 1 is embodied, the jetting and solidifying processes of the transparent UV curable ink performed on specific areas of the patterns of the work piece 2 can be repeated based on the design of the graphic data, in order to adjust the overall thickness of the transparent color layer or to show an embossed effect of specific patterns on the surface of the transparent color layer.

Therefore, the digital inkjet printing machine with transparent ink of the present invention has the following advantages:

1. The structure of the present invention is different from that of the conventional digital inkjet printing machine or printer for large-format prints. By forming the water-proof, solvent-proof and wear-proof transparent color layer on the printed patterns of the work piece by applying the transparent UV curable ink, the surface of the printed work piece is brightly colored and the patterns on the work piece are embossed. Thus the application of the digital inkjet printing machine can be enhanced.

2.The present invention can omit the conventional process of liquid coating or cold laminating and the time required for the printed work piece. The expected lifespan and the presented effect of the printed work piece can be enhanced in order to increase the practicability and competitiveness of the digital inkjet printing machine.

As a conclusion from the above, the objectives can be achieved by the digital inkjet printing machine of the present invention. By forming the three-dimensional transparent color layer on the surface of the printed work piece, the effects presented on the patterns of the printed work piece can be enhanced.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A digital inkjet printing machine with transparent ink, wherein a work piece on a working platform is heated during or after the jetting of ink on the work piece in order to harden the ink droplets on the work piece, the digital inkjet printing machine comprising:
an inkjet module having a plurality of colored ink cartridges and at least one transparent ink cartridge filled with transparent UV curable ink; and
at least one UV light projection device disposed on a side of the inkjet module for irradiating UV light downward on a surface of the work piece on the working platform in order to solidify the transparent UV curable ink droplets jetted on the surface of the work piece.

2. The digital inkjet printing machine with transparent ink as claimed in claim 1, wherein the colored ink cartridges are filled with solvent based ink.

3. The digital inkjet printing machine with transparent ink as claimed in claim 1, wherein the colored ink cartridges are filled with non-solvent ink.

4. The digital inkjet printing machine with transparent ink as claimed in claim 1, wherein the colored ink cartridges are filled with eco-friendly solvent based ink.

5. The digital inkjet printing machine with transparent ink as claimed in claim 1, wherein the colored ink cartridges are filled with water based ink.
